(19) United States
(12) Patent Application Publication
(10) Pub. No.: US 2026/0100398 A1
(43) Pub. Date: Apr. 9, 2026

(54) APPARATUS, SYSTEM AND METHOD FOR CONTINUOUS SINGULATED ELECTRODES

(71) Applicant: DW Energy LLC, Wilsonville, OR (US)

(72) Inventors: Dan Alexander Sturges, Lake Oswego, OR (US); Brady L. Byers, Newberg, OR (US); Christopher E. Barns, Portland, OR (US); Derek Graham Aqui, Portland, OR (US); Gautam Dhar, Tualatin, OR (US); Alex Montes, Portland, OR (US)

(21) Appl. No.: 19/351,800

(22) Filed: Oct. 7, 2025

Related U.S. Application Data
(60) Provisional application No. 63/704,056, filed on Oct. 7, 2024.
(60) Provisional application No. 63/704,068, filed on Oct. 7, 2024.

(51) Int. Cl. H01M 10/04

(52) U.S. Cl. CPC H01M 10/0404; H01M 10/0459

(57) ABSTRACT

The present disclosure relates to apparatus, systems, and methods for continuous motion battery stacking by picking singulated electrodes and separators and placing each into a stack secured on a downstream process of a battery stacking system. The continuous singulated battery stacking system includes a rotating electrode transfer device integrated with a deformable shoe mechanism for handling electrodes during high-precision stacking processes and adjusting dynamically to the shape of the in-feed and downstream conveying surfaces, allowing for smooth, continuous contact during pick-and-place operations. This flexibility ensures consistent pressure distribution and minimizes the risk of misalignment or damage during transfer. Adapting in real time, the deformable shoe enhances alignment, reduces machine wear, and maintains high accuracy in stacking processes, especially for sensitive materials like lithium foil or separators. This innovation optimizes high-speed stacking, contributing to improved battery manufacturing efficiency and reliability.

### CROSS-REFERENCE TO OTHER APPLICATION

This application claims the benefit of and priority to U.S. Provisional Application Nos. 63/704,056 and 63/704,068 filed Oct. 7, 2024, the contents of which are hereby incorporated by reference.

### COPYRIGHT NOTIFICATION

Portions of this patent application contain materials that are subject to copyright protection. The copyright owner has no objection to the facsimile reproduction by anyone of the patent document or the patent disclosure, as it appears in the U.S. Patent and Trademark Office, but otherwise reserves all copyright rights whatsoever.

### FIELD OF THE DISCLOSURE

The present invention generally relates to apparatus, systems, and methods for continuous motion battery stacking and, in particular, to one or more methods and apparatuses for continuously picking singulated electrodes and separators and placing each into a stack secured on a downstream process as part of a battery stacking system.

### BACKGROUND OF THE DISCLOSURE

Battery stacking, a critical process in modern battery manufacturing, involves arranging multiple battery cells to form a complete module or pack. The cells, which can be cylindrical, prismatic, or pouch-shaped, are stacked in layers with alternating anode and cathode layers, separated by insulating separators. This stacking process aims to increase the energy density and power capacity of battery systems, making it a key technology in applications such as electric vehicles (EVs), grid storage, and portable electronics. The stacking process must ensure consistent alignment and minimal spacing to avoid performance losses or safety risks due to short circuits or thermal events.

In the stacking process, automated systems are often used to handle the precise placement of electrodes and separators. The critical challenge in battery stacking manufacturing is maintaining high throughput while ensuring the accurate alignment of each layer. This is particularly important in high-performance batteries, such as those using lithium-ion chemistry, where even slight misalignments can affect the electrochemical performance and lifecycle of the battery. Innovations in automation and robotics, such as laser alignment and machine vision systems, are increasingly employed to improve the precision and speed of the stacking process. This not only enhances production efficiency but also significantly reduces the cost of high-volume battery manufacturing, painting an optimistic picture of the future of the industry.

Another essential consideration in battery stacking manufacturing is the need for effective quality control. As batteries become more energy-dense and are used in safety-critical applications, such as EVs, the quality and consistency of the stacking process must be monitored in real time. Techniques like X-ray inspection and impedance spectroscopy detect defects, such as misaligned cells or foreign particles, that may lead to performance degradation or safety issues. As the demand for higher-capacity batteries continues to grow, further advancements in automation, materials handling, and defect detection technologies will be crucial for scaling up battery stacking manufacturing while maintaining stringent safety and performance standards.

Z-stacking, also known as Z-folding, batteries, while offering higher energy density by vertically stacking cells in layers, comes with several limitations and challenges. One of the primary issues is the difficulty in ensuring precise alignment across multiple layers, as any misalignment can result in uneven pressure distribution, leading to mechanical stress on the electrodes and separators. In extreme cases, this can cause performance degradation, internal short circuits, or even thermal runaway. Because Z-stacking requires continuously offsetting the separator web from side-to-side during lamination to fold over to the next layer, visually inspecting the stack for accuracy and minimizing excess electrode and separator material to prevent the mechanical issues described above are difficult and expensive to implement, leading to higher manufacturing costs due to large amounts of wasted material per stack manufactured.

Another challenge is heat dissipation; with cells stacked closely together, heat can accumulate within the pack, increasing the risk of overheating and reducing the battery's overall lifespan. Additionally, the complexity of automated stacking processes, particularly for thin and flexible components like separators in lithium-ion batteries, can lead to manufacturing defects if not carefully controlled. These limitations highlight the need for advanced manufacturing techniques and rigorous quality control measures to ensure the safety and reliability of Z-stacked batteries in high-demand applications like electric vehicles and energy storage systems.

Therefore, what is missing in battery stacking systems today is a continuous singulated battery stacking system and method that contains more advanced alignment technologies and real-time quality control methods that can ensure greater precision and reduce manufacturing defects at scale than traditional Z-stacking systems.

### BRIEF SUMMARY OF THE DISCLOSURE

This summary is provided to introduce a selection of concepts in a simplified form that are further described in the detailed description of the disclosure. This summary is not intended to identify key or essential inventive concepts of the claimed subject matter, nor is it intended to determine the scope of the claimed subject matter.

The present invention generally relates to an apparatus, system and method for continuously picking singulated electrodes and separators and placing each onto a stack that is secured onto a downstream battery stacking process.

As disclosed herein, the battery stacking system includes a first in-feed conveyor configured to transport singulated anode sheets from an upstream singulations region and a second in-feed conveyor configured to transport singulated cathode sheets from an upstream singulations region. A third in-feed conveyor is configured to transport singulated separator sheets from an upstream singulation region. The system also further includes a transfer device and a gripping shoe configured to transfer an anode, a cathode, and a separator from the respective first, second, and third in-feed conveyors to a picking prism using the gripping shoe. The picking prism is further configured to pick the anode, cathode, and separator from the gripping shoe of the transfer device using one of at least three gripping shoes coupled to the picking prism. In other embodiments, the system also includes a rotating transfer device with at least one deformable vacuum-assisted gripping shoe, which is configured to transfer an anode, a cathode, and a separator from the respective first, second, and third in-feed conveyors to a rotating picking prism using the deformable vacuum-assisted gripping shoe.

In an embodiment of the present disclosure, the battery stacking system includes a rotating transfer device that is adapted to alternately transfer an anode and a cathode to the rotating picking prism.

In another embodiment of the present disclosure, the battery stacking system includes a transfer device that has one position in which it is at least three gripping shoes coupled to an anode and releasing a cathode, and another position in which it is simultaneously gripping a cathode and releasing an anode.

In yet another embodiment of the present disclosure, the battery stacking system includes quality inspection devices that are adapted to inspect the cathodes, separators, and anodes before they are transferred to the rotating transfer device.

In an embodiment of the present disclosure, the battery stacking system includes quality inspection devices that are adapted to inspect the cathodes, separators, and anodes before they are transferred to the rotating picking prism.

In another embodiment of the present disclosure, the battery stacking system includes an alignment device on each of the first, second, and third in-feed conveyors, which is configured to align the electrodes and separators while they are on the conveyor.

In yet another embodiment of the present disclosure, the battery stacking system includes an alignment device on each of the rotating transfer devices, which is configured to align the electrodes and separators while they are continuously in motion and being transferred to the rotating picking prism.

In an embodiment of the present disclosure, the battery stacking system includes a rotating picking prism with at least three gripping shoes, each having a surface adapted to adhere an electrode via vacuum. The surface includes a plurality of vacuum zones that can be individually controlled. The system also includes at least one processor configured to track the angular position of the plurality of vacuum zones, determine when at least one of the vacuum zones has reached a predetermined angular position, and deactivate the vacuum in at least one of the zones when the predetermined angular position is reached.

In another embodiment of the present disclosure, the battery stacking system includes a rotating picking prism that is adapted to push on the electrode or separator with an air jet when the vacuum is turned off.

In yet another embodiment of the present disclosure, the battery stacking system includes a first battery stacking station adapted to receive at least one singulated anode, at least one singulated cathode, and at least one singulated separator material, and a second battery stacking station adapted to receive the same materials. Each of the battery stacking stations is designed to be positioned at a battery stacking position and a battery removal position. The system also includes a removal device adapted to remove a battery stack from either the first or second battery stacking station when it is in the battery removal position.

In an embodiment of the present disclosure, the battery stacking system includes a vacuum source fluidly coupled to both the first and second battery stacking stations. The vacuum source is adapted to exert a suction force on the battery stack that encircles the stack.

In another embodiment of the present disclosure, the battery stacking system includes each battery stacking station positioned on a mechanical transportation device, allowing it to move along at least two axes that are perpendicular to each other.

In yet another embodiment of the present disclosure, the battery stacking system includes each battery stacking station comprising a movable side wall.

In an embodiment of the present disclosure, the battery stacking method includes stacking anodes, cathodes, and separator material on a first battery stacking station at a stacking position until a first battery stack is produced, then moving the first battery stacking station to a removal position and moving a second battery stacking station to the stacking position. Anodes, cathodes, and separator material are then stacked on the second battery stacking station until a second battery stack is produced, followed by removing the first battery stack from the first battery stacking station.

In another embodiment of the present disclosure, the battery stacking method includes removing the first battery stack from the first battery stacking station while the second battery stack is being stacked on the second battery stacking station.

In yet another embodiment of the present disclosure, the battery stacking method includes moving the second battery stacking station to the removal position and moving the first battery stacking station back to the stacking position.

In an embodiment of the present disclosure, the battery stacking method includes moving the first battery stacking station to the battery removal position at the same time the second battery stacking station is moved to the battery stacking position, and vice versa.

The present disclosure relates to a battery manufacturing device capable of creating a battery stack using a continuous singulated lamination process by successively controlling a plurality of parameters, including the above-mentioned novel features, such as (but not limited to), in various embodiments, the alignment of anode and cathode sheets, the tension of separator materials, the output speed of in-feed conveyors, and the pressure applied to the stack, battery material and the temperature within the battery material.

As disclosed herein, the battery manufacturing device includes various sensors, including but not limited to pressure sensors, alignment sensors, tension sensors, temperature sensors, vibrational sensors, and cameras to ensure precise stacking and quality control.

### BRIEF DESCRIPTION OF THE DRAWINGS

The foregoing summary, as well as the following detailed description of the disclosure, is better understood when read in conjunction with the appended drawings. For the purpose of illustrating the disclosure, exemplary constructions of the inventions of the disclosure are shown in the drawings. However, the disclosure and the inventions herein are not limited to the specific methods and instrumentalities disclosed herein.

FIG. 1 shows a system for transferring electrodes in accordance with an embodiment of the present disclosure.

FIGS. 2A-2C show different stages of an operation for releasing a battery stack material in accordance with an embodiment of the present disclosure.

FIGS. 3A-3C illustrate an alternate transportation device 100 of FIG. 1 in accordance with an embodiment of the present disclosure.

FIGS. 4A-4C illustrate an alternate transportation device 100 of FIG. 1 in accordance with an embodiment of the present disclosure.

FIGS. 5A-5C illustrate an alternate transportation device 100 of FIGS. 2A-2C in accordance with an embodiment of the present disclosure.

FIG. 6 illustrates a rotating transfer device configured with a deformable shoe in accordance with an embodiment of the present disclosure.

FIG. 7A illustrates a rotating cam plate in accordance with an embodiment of the present disclosure.

FIG. 7B illustrates a rotating cam plate and cam follower in accordance with an embodiment of the present disclosure.

FIG. 8 illustrates a deformable shoe in accordance with an embodiment of the present disclosure.

FIG. 9 illustrates a front view of a deformable shoe in accordance with an embodiment of the present disclosure.

FIG. 10 illustrates a bottom view of a deformable shoe in accordance with an embodiment of the present disclosure.

FIG. 11 shows a battery stacking station in accordance with an embodiment of the present disclosure.

FIGS. 12-15B show a battery stacking system in accordance with an embodiment of the present disclosure.

### DETAILED DESCRIPTION OF THE DISCLOSURE

The following disclosure as a whole may be best understood by reference to the provided detailed description when read in conjunction with the accompanying drawings, drawing description, abstract, background, field of the disclosure, and associated headings. Identical reference numerals when found on different figures identify the same elements or a functionally equivalent element. The elements listed in the abstract are not referenced but nevertheless refer by association to the elements of the detailed description and associated disclosure.

In the following detailed description, reference is made to the accompanying drawings that show, by way of illustration, a possible industrial embodiment of the disclosure centered around an improved battery stacking system. This embodiment is described with detail sufficient to enable one of ordinary skill in the art to practice the disclosure. It is understood that each subfeature or element described in this embodiment of the disclosure, although unique, is not necessarily exclusive and can be combined differently and in a plurality of other possible embodiments because they show novel features.

It is further understood that the location and arrangement of individual elements, such as geometrical parameters within each disclosed embodiment, may be modified without departing from the spirit and scope of the disclosure. The disclosed apparatus can be modified according to known design parameters to implement this disclosure within these specific types of operation. Other variations will also be recognized by one of ordinary skill in the art. Therefore, the following detailed description is not to be taken in a limiting sense.

### System for Transferring Electrodes to a Battery Stack

The present disclosure relates to a system for continuously stacking singulated electrodes and separator material 100 and its parts, as shown in the associated figures, for continuously stacking singulated electrodes and separators using a lamination process.

As stated above, existing approaches to stacking electrodes and separator material have difficulty ensuring precise alignment across multiple layers, resulting in uneven pressure distribution, mechanical stress on electrodes and separators, performance degradation, internal short circuits, and thermal runaway. The existing approaches also have difficulty inspecting the electrodes and stack for placement accuracy due to manufacturing constraints related to using a continuous separator web. For instance, if the alignment of the layers is not correct, the stack will have to be trimmed, or the overall battery capacity will be reduced, which leads to higher manufacturing costs and wasted material. The stacking system 100 solves these issues by allowing for the continuous stacking of singulated electrodes and separator material while maintaining accuracy and manufacturing speeds not possible with existing methods.

Anodes and cathodes are referred to collectively as electrodes. A collection of alternating anodes and cathodes with a separator between adjacent anodes and cathodes is called a battery stack. Anodes, cathodes, and separators are referred to collectively as battery material.

As illustrated in the accompanying figures, the stacking system 100 comprises a first transportation device 110 for transporting a first electrode 115 towards a rotating picking device or prism 170. The system also includes a second transportation device 120 for transporting a second electrode 125 towards the rotating picking device 170. The rotating picking device 170 is adapted to pick up an electrode from the transfer device 150 and then deposit the electrode at a battery stack 180, positioned at a battery stacking station 185. One of the electrodes, 115 or 125, is typically an anode, while the other one is the cathode. Transportation devices 110 and 120 may be any type of transportation device suitable for the system, such as a conveyor.

The in-feed conveyor systems, first transportation device 110 and second transportation device 120, for battery stacking are designed to transport singulated anode, cathode, and separator sheets from upstream processes to the transfer device 150 and rotating picking device 170 with high precision and synchronization.

These conveyors contain one or more lanes or belts dedicated to different materials (anode, cathode, separator) to ensure seamless feeding into the stacking process. Equipped with features like vacuum-assisted gripping mechanisms, sensors, and alignment devices, these conveyors ensure that each component is correctly positioned and aligned before entering the stacking system 100.

It is to be noted that advanced systems often integrate tension controls, speed adjustments, and robotic arms to handle delicate and thin materials, mainly separators, which are prone to deformation. Additionally, real-time quality checks such as optical or X-ray inspection systems can be incorporated along the conveyors to detect defects in materials before they reach the stacker, ensuring consistent quality and minimizing the risk of downstream issues.

While both transportation devices 110 and 120 are typically the same type of transportation device, the type may differ between implementations. In embodiments wherein the transportation devices 110 and 120 are conveyors, the conveyors are configured to transport the battery material using suction to keep the battery material adhered to the surface of the conveyor. In some embodiments, the conveyor may be inverted and transport the electrodes 115 and 125 on the bottom rather than the top. In embodiments with an inverted conveyor, some mechanism for adhering the electrode to the conveyor is required, which may be suction generated using a vacuum source (not shown). The advantages of conveying singulated electrodes are that it removes the need for cassettes and the system architecture associated with their loading, unloading, and conveying. When the need for cassettes is removed, the machine footprint shrinks considerably, and a high-speed stacker can run for longer durations.

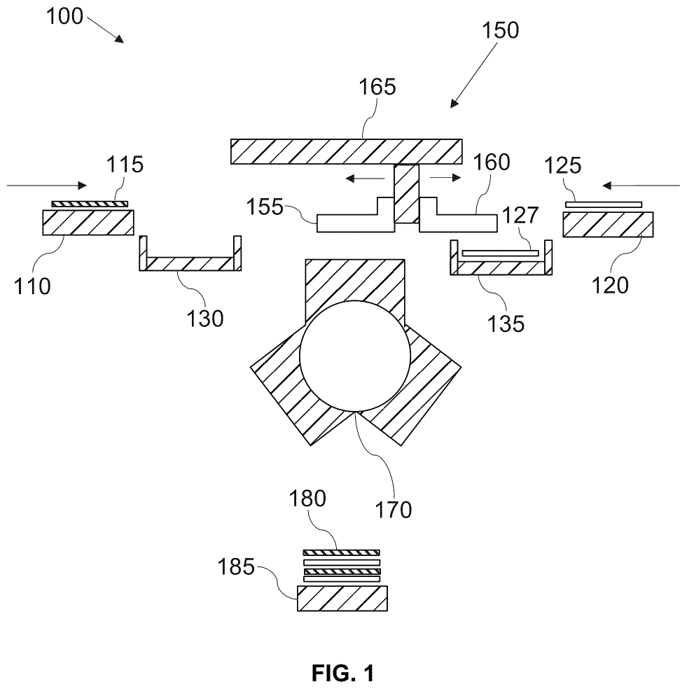

The stacking system 100 includes a first nest 130 adapted to receive the first electrode 115 and a second nest 135 adapted to receive the second electrode 125. In FIG. 1, there is one electrode 127 positioned within the second nest 135. The nests 130 and 135 are adapted to receive the singulated electrodes from the conveyors. In some embodiments, intermediate devices may facilitate the transfer from the transportation devices 110 and 120 to the respective nests 130 and 135. In some embodiments, Bernoulli grippers are positioned between the transportation devices 110 and 120 and the respective nests 130 and 135. These Bernoulli grippers employ suction to keep the electrodes from falling down toward the nests too early.

The nests 130 and 135 are adapted to transfer the electrodes 115 and 125 to a transfer device 150. The transfer device 150 comprises a first gripper 155 and a second gripper 160. The first gripper 155 and second gripper 160 are configured to pick up the electrodes 115 and 125 from the nests 130 and 135 and transport them to the rotating picking device 170.

In an embodiment, the transfer device 150 is configured to move back and forth between the nests 130 and 135 to alternately pick up an anode and a cathode and deliver them to the rotating picking device 170.

The grippers 155 and 160 employ suction to pick up the electrodes 115 and 125 from the nests. The grippers 155 and 160 include vacuum chucks. The grippers 155 and 160 are also configured to use a stream of air to push the electrodes 115 and 125 away from the grippers 155 and 160 when releasing them to the rotating picking device 170. In an embodiment, the switching between generating a vacuum or a jet of air is achieved using plumbed-in baffles within the grippers 155 and 160.

In an embodiment, nests 130 and 135 include air bearings on a bottom surface, which receive the electrodes 115 and 125 from the first transportation device 110 and the second transportation device 120, conveyor, and/or any optional intermediate devices. In some embodiments, nests 130 and 135 use suction and/or jets of air at various positions and timings in the nests 130 and 135, such that some parts or zones of the nest provide air as a cushion for the electrodes 115 and 125, while other parts or zones of the nests 130 and 135 employ a vacuum for adhering the electrode to the nests 130 and 135.

As disclosed herein, this may be achieved by vacuum-preloaded air bearings with switchable vacuum zones. In an embodiment, the switching between generating a vacuum or a jet of air is achieved using plumbed-in baffles within nests 130 and 135. As further illustrated, the nests 130 and 135 move back and forth along a vertical axis, i.e., up and down. An electrode 127 is received at a nest 135 when the nest 135 is in a bottom position, and the bottom of the nest 135 is moved upwards to be at a top position when a transfer is made to the gripper 160. In some embodiments, the nests 130 and 135 move up and down by a shaft positioned on an eccentric lobe, which rotates eccentrically around an axis and moves the nest up and down during one revolution.

In various other embodiments, nests 130 and 135 include an alignment device that is configured to align the singulated battery material. It is beneficial to have the battery material positioned at the same, or substantially the same, position each time a transfer to the transfer device 150 is made. In some embodiments, the alignment device includes one or more brushes that are pushed against one or more sides of the battery material to maintain a predetermined alignment. In an embodiment, the alignment device includes one or more wheels that are used to push or pull one or more sides of the battery material to maintain a predetermined alignment. In an embodiment, the alignment device includes one or more vacuum or jet regions that are used to push or pull one or more sides of the battery material to maintain a predetermined alignment.

After the electrode 115 or 125 has been transferred to a gripper 155 or 160 of the transfer device 150 from the respective nests 130 and 135, the transfer device 150 moves towards the rotating picking device 170. When the gripper 155 or 160 holding electrode 115 or 125 reaches the rotating picking device 170, the electrode 115 or 125 is handed over to the rotating picking device 170. In some embodiments, the electrode 115 or 125 is gripped by suction by the rotating picking device 170. In some embodiments, the suction of the transfer device 150 is turned off when the rotating picking device 170 comes in contact with the respective gripper 155 or 160. In some embodiments, the rotating picking device 170 employs a stronger suction than the grippers 155 and 160, which enables it to pick the electrodes 115 and 125 from the grippers 155 and 160 without releasing their suction. In some embodiments, the electrodes may be handed over to another.

In an embodiment, the transfer device 150 is positioned such that while one gripping device 160 is gripping an electrode 127 in the nest, the other gripping device 155 is positioned to release another electrode (not shown) onto the rotating picking device 170. In such embodiments, the transfer device 150 stops or moves very slowly at both gripping and releasing positions. As will be understood, there are in such embodiments two mirrored positions for the transfer device 150, one where it is picking an anode and simultaneously releasing a cathode, and one position where it is picking a cathode and simultaneously releasing an anode.

In some embodiments, the electrodes 115 and 125 may be handed over to another subsequent station of the battery stacking system, then rotating picking device 170.

In some embodiments, the rotating picking device 170 includes multiple faces or shoes and is configured to rotate eccentrically in order to first pick up an electrode 115 or 125 from the transfer device 150 before depositing the electrode 115 or 125 at the battery stacking station 185.

The use of an eccentrically rotatable multi-sided picking device 170 having at least three faces or shoes with arcuate gripper surfaces allows for continuous rotary motion based on a Reuleaux triangle. By having the rotating picking device 170 rotating according to a Reuleaux triangle, constant width rotation within a square space is possible while simultaneously touching all four sides. However, two challenges arise with a pure Reuleaux triangle design: the complex non-circular orbital motion at the triangle's center and the “scrubbing” effect caused by relative motion between the curved surface and electrodes during pick-and-place operations. These issues can be addressed through motion control or cam design, but a more straightforward rotary motion may be beneficial. To solve these problems, a modified Reuleaux triangle is proposed, featuring a non-slip profile path for the centroid to ensure pure rolling motion at the curved surface of the at least three faces or shoes, where the rolling distance matches the lateral movement of the triangle's top vertex.

In other embodiments, having additional faces or shoes is also possible. In fact, the rotating picking device 170 can be configured to have up to N faces in a N+1 system. Skilled persons will also appreciate that closed-form analytical techniques may be employed to develop arcuate gripper surface shapes. For example, the rotating picking device 170 can be configured to have four shoes orbiting in a five sided space. Having an even number of shoes allows for dedicated shoes for anodes and cathodes, which minimizes material cross contamination and increases the throughput of the rotating picking device 170.

In an embodiment, the rotating picking device 170 is configured to pick and release separator material and deposit the separator material between anodes and cathodes on the battery stack. The separator material may be transported together with the electrodes 115 and 125 or transported separately. When the separator material is transported independently, the rotating picking device may be configured to pick a sheet of singulated separator material on alternating faces or shoes from electrodes 115 and 125 from the face of an upstream singulation region utilizing vacuum and air jets to hold and place the singulated sheet. In some embodiments, the rotating picking device 170 picks up multiple layers simultaneously, e.g., an electrode and a separator. There are two different picking strategies if the rotating picking device 170 is configured to pick up multiple layers. The first is the “conventional” pick, where the rotating picking device 170 is configured to pick a layer of separator first. Then, an electrode is on top of the separator material, and then transfers both the separator material and the electrode on the battery stack 180 at the same time. This strategy relies on the porosity of the separator. If the porosity is too low, the electrode will not be picked up at high speeds.

The second picking strategy is the “inverted” pick. The inverted pick strategy uses a high flow, “leaky” end effector to pick the electrode first and the separator second. The high-flow end effector allows the separator to be picked and securely held due to the constant airflow around the edges of the electrode which creates a suction force. Using the inverted pick method is porosity independent, thus allowing non-porous separators to be picked. This allows the stacking system 100 to handle a greater range of battery topologies, including prismatic, pouch-shaped, solid-state, or lithium foil-based.

In some embodiments, the stacking system 100 includes at least one rejection device for rejecting faulty or misaligned electrodes. The stacking system 100 may also include quality inspection devices, such as optical cameras, for determining if an electrode is faulty or misaligned. In an embodiment, the rejection devices are positioned between both transportation devices 110 or 120 and the respective nests 130 and 135. In another embodiment, rejection is handled using the transfer device 150. In some embodiments, the rejection devices are in the form of reject chutes, into which the electrodes are dropped. In case the transportation devices 110 and 120 are inverted conveyors using suction to adhere the electrodes to them, rejecting an electrode may comprise releasing the suction and possibly use of an air jet to also push the electrode towards a reject chute positioned directly below the respective transportation device 110 or 120.

Battery quality is a measurement of electrode placement accuracy. Quality inspection systems for battery stacking ensure that the electrodes (anodes and cathodes) and separators are properly aligned and defect-free before and during the stacking process. These systems often employ advanced technologies such as optical, X-ray, or laser-based sensors to detect misalignments, foreign particles, or material defects that could compromise battery performance and safety. Real-time monitoring is essential, as even minor deviations can lead to short circuits, reduced capacity, or thermal events. Inspection systems may also include impedance spectroscopy and other electrical testing methods to verify the integrity of the stacked layers. Integrated with automation, these quality control systems enable continuous monitoring and corrective actions, minimizing defects and ensuring high reliability in the final battery stacks used in electric vehicles, energy storage, and other applications. In an embodiment, the quality inspection device includes an optical camera 123 for determining if an electrode is faulty or misaligned. The control box 190 may be configured to receive real-time images of the edges of the battery material to detect misalignments and defects. If a misalignment or defect is detected, the control box 190 sends a signal to either the rejection device, the battery stacking station 185, or the battery stack removal system 400 to initiate a rejection process of the individual sheet of battery material or the entire stack.

In some embodiments, the quality inspection system is configured to generate a digital twin of the entire battery stack throughout the entire stacking process. Using a digital twin in quality inspection for battery stacking systems offers numerous benefits by creating a real-time, virtual replica of the physical manufacturing process. This advanced method allows manufacturers to simulate, monitor, and optimize production without interrupting the workflow. A digital twin can track and analyze data from various sensors in the battery stacking system, providing insights into potential defects, misalignments, or inconsistencies in the stacking of electrodes and separators. Manufacturers can make immediate adjustments by predicting issues before they occur, minimizing downtime, and reducing waste. Additionally, the digital twin enhances predictive maintenance by monitoring the health and performance of machinery, preventing breakdowns. Overall, this method improves the precision, efficiency, and reliability of the battery manufacturing process, ensuring higher quality control standards and reducing production costs.

For example, the stacking system 100 can compare the digital twin for various stacks, lots, or even individual battery material sheets as they move throughout the stacking system 100. By comparing the digital twin at multiple checkpoints throughout the stacking process, control box 190 can determine if there is an issue with a specific subsystem. Additionally, by comparing the digital twins between various lots of batteries, the control box 190 can automate the detection, classification, and reporting of potential recalls due to misalignments or defects.

In an embodiment, the quality inspection system is enhanced by using cameras 123 in conjunction with strategically placed mirrors 260 to enable real-time optical inspection of the battery stack. This configuration works by bouncing the optical image off the rotating picking device 170, allowing the system to capture a clear view of the top layer of the battery stack 180 on the stacking platform 185. This method provides a non-invasive and highly accurate way to inspect the alignment, positioning, and condition of the anodes, cathodes, and separators as they are stacked. By using mirrors to reflect the image, the system can inspect layers without interrupting the stacking process, ensuring continuous monitoring. This setup also helps detect defects or misalignments in real time, allowing for immediate corrective action, which enhances overall product quality and reduces waste. The camera and mirror system provides an efficient and cost-effective means of ensuring precision in high-speed battery stacking operations.

In some embodiments, the system further comprises electrode cleaning stations upstream of the respective transportation devices 110 and 120. The cleaning stations are adapted to clean and optionally deburr the electrodes 115 and 125 prior to transporting them to the rotating picking device 170.

Such electrode cleaning stations may comprise two air bearings opposite to and close to each other, such that electrodes 115 and 125 are transported through the two air bearings to clean and deburr them using the air pressure. In an embodiment, the distance between two such air bearings is the same as the distance between the electrodes, which may be less than two microns. In embodiments, the distance between two such air bearings may be larger than the distance between the electrodes. Other spacings will be readily appreciated by a person of skill in the art and may be selected based on other parameters of the system. In various embodiments, the cleaning stations may, in some embodiments, include other ways of cleaning the electrodes, such as ultrasonic cleaning, solvent baths, or electrocleaning. The cleaning stations may also comprise other means of deburring the electrodes, such as mechanical brushing, abrasive blasting, or chemical deburring.

A control box 190 (not shown) is coupled to the stacking device 100. The control box 190 includes various control components or processors, such as PLCs, sensors, displays, etc., that adjust multiple parameters, receive sensor data, and control the stacking device 100. The control box 190 is configured to control various functions of the stacking device 100, including but not limited to rejection, quality inspection, battery material alignment, pick and place operations, and vibrational analysis. A person of skill in the art would understand that the discrete tasks disclosed throughout may be performed within a single control box 190 or multiple control box 190s, depending on the needs of the upstream and downstream processes.

Vibrational analysis plays a critical role in monitoring and optimizing battery stacking machines by detecting mechanical irregularities or misalignments in real time. This technique measures the vibration patterns of moving components, such as conveyors, transfer devices, and grippers, during the stacking process. Any deviation from normal vibration signatures can indicate issues like wear, imbalance, or misalignment in the machinery, which could negatively affect the precision of stacking anodes, cathodes, and separators. By identifying these anomalies early, operators can prevent potential defects in battery stacks, such as misaligned electrodes, which may lead to performance degradation or safety risks. Additionally, vibrational analysis can help optimize machine performance, ensuring smoother operation, longer machine life, and reduced downtime for maintenance, contributing to overall efficiency and cost-effectiveness in battery manufacturing. In an embodiment, the control box 190 performs vibrational analysis on the stacking system 100 to ensure proper alignment and operation during stacking.

In an embodiment, the control box 190 is configured to monitor the temperature throughout the stacking system 100. Temperature-related issues in cathodes, anodes, and separator materials can significantly affect the performance, safety, and longevity of batteries. Excessive heat can cause degradation in cathode and anode materials, leading to a loss in electrochemical performance, reduced capacity, and shorter battery life. Elevated temperatures can also damage the delicate separator material, which serves as a barrier between the anode and cathode to prevent short circuits. If the separator material shrinks, melts, or develops holes due to heat, it can result in internal short circuits, increasing the risk of thermal runaway and potential battery fires. Additionally, fluctuations in temperature can cause uneven thermal expansion, leading to misalignment of the electrodes and separators, further degrading battery performance. Effective thermal management is, therefore, crucial in battery stacking and assembly processes to ensure the integrity and safety of the final product.

The control box 190 may also be configured to activate or deactivate various upstream or downstream apparatuses, such as transportation devices 110 and 120.

In an embodiment, the control box 190 includes a display (not shown) configured to display a human-machine interface (“HMI”) containing information on the stacking system 100. A user may interact with the HMI and display to set various parameters of the stacking system 100.

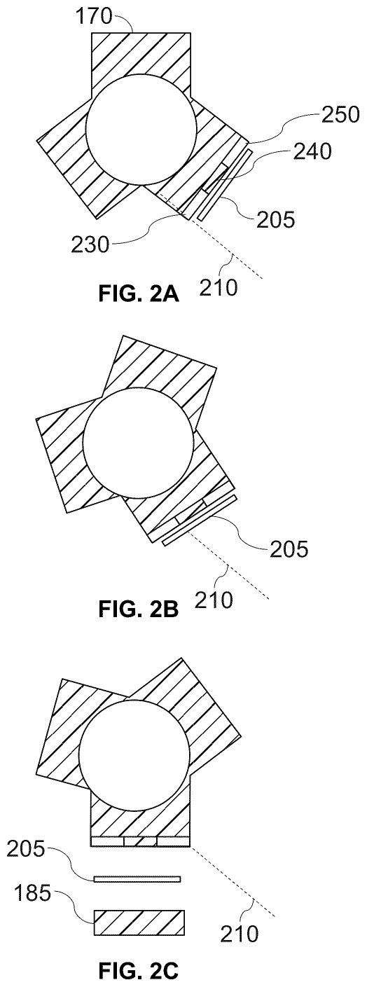

As shown in FIG. 2, when transferring an electrode 115 or 125 from, e.g., the picking device 170 to the battery stacking station 185, the electrodes are released in several steps, i.e., gradually rather than all at once. By releasing electrodes 115 and 125 one part at a time, a smoother and more accurate transfer may be achieved, decreasing the risk of damaging the electrode. In the embodiment described below, the gradual transfer of an electrode is performed by the rotating picking device 170, where each face or show of the rotating picking device 170 includes multiple vacuum zones, e.g., 230, 240, and 250, for adhering and propelling electrodes 115 and 125 to/from the surface of the rotating picking device 170.

To achieve a gradual transfer, the surface of the faces or shoes of the rotating picking device 170 contains multiple zones 230, 240, and 250 in which a vacuum or jet of air may be applied individually. The angular position of each vacuum zone is tracked to determine if the various vacuum zones 230, 240, and 250 have reached a predetermined position.

In order to keep track of individual zones 230, 240, and 250, standalone devices may be used. Such devices may be standalone processing devices comprising processing circuitry, such as a microcontroller or digital signal processor, which may include one or more programmable processors, application-specific integrated circuits, field programmable gate arrays, or combinations.

One example of such a device is an output compare device, adapted to compare a value against another value and optionally perform an action when a specific value is detected or exceeded.

When the predetermined position is reached, the multiple vacuum zones 230, 240, and 250 are turned off. When this predetermined position is reached for the specific zone, the standalone device signals that the vacuum is to be turned off. The same applies to the standalone device of the next zone, the next, and so on.

In some embodiments, the standalone device is adapted to transmit its position to another processing or computing device. Such a computing device may be associated with the picking device 170, which keeps track of the rotating picking device 170's position. The computing device of the rotating picking device 170 may be adapted to turn on and off the vacuum zones. Data between processing devices and/or computing devices may be transmitted wirelessly. Using electronics to track and actuate the multiple vacuum zones 230, 240, and 250 may lead to higher maintenance costs due to the high cycles experienced by the high-speed stacking system 100.

In an alternative embodiment, instead of relying on electronic control systems to manage the multiple vacuum zones 230, 240, and 250, the design incorporates a series of internal baffles, plumbing, and mechanical valves. These components enable the rotating picking device 170 to mechanically switch the vacuum and air jets on and off without the need for complex electronics. As the rotating device moves through its cycle, the internal baffles direct airflow to specific zones, automatically activating or deactivating the vacuum and air jets in sync with the machine's motion. This mechanical approach simplifies the system, reducing reliance on electronic components, which can be prone to failure or require significant maintenance. It also offers a more robust and potentially cost-effective solution, especially in environments where durability and reliability are critical. This system can streamline the manufacturing process by minimizing the need for electronic controls while maintaining precise control over the gripping and release of materials during battery stacking operations. By eliminating electronics, such as relays, the rotating picking device 170 is able to reduce downtime and maintenance costs.

This is illustrated in FIGS. 2A-2C. In FIG. 2A, the picking device adheres electrode 205 to its surface using a vacuum. The face of the picking device holding the electrode 205 comprises a first vacuum zone 230, a second vacuum zone 240, and a third vacuum zone 250. The same applies to FIGS. 2B and 2C, but references are omitted.

As the rotating picking device 170 rotates from the position in FIG. 2A towards the release position in FIG. 2C, it passes the predetermined level 210 for when the vacuum is to be turned off. Since each zone 230, 240, and 250 is associated with its processing device or set of internal plumbing, the respective processing device keeps track of its position relative to the predetermined position 210. It turns off the vacuum when that position is reached.

In FIG. 2B, the first vacuum zone, 230, has been turned off, and the second vacuum zone, 240, is about to be turned off. When the picking device 170 reaches the position of FIG. 2C, the third zone 250 is also released, which results in electrode 205 being released from the rotating picking device 170 towards battery stacking station 185. In some embodiments, it may be released with virtually no distance to the battery stack, and in some embodiments, it may be released and fall some distance before it reaches the battery stack.

In some embodiments, the rotating picking device 170 may be adapted to use air to push electrode 205 away from the rotating picking device 170 as it is being released. This may entail that when the respective zones 230, 240, and 250 pass the predetermined position 210, the vacuum is turned off, and an air jet is turned on.

Throughout this document, multiple devices use suction to adhere electrodes and/or separator material to them. Such suction may be achieved using differential pressure, which a vacuum may achieve.

In some embodiments, the suction may be replaced by other means of adhering a material to a surface. Such means may be, e.g., mechanical clamping, electrostatic, tacky or sticky surfaces, and similar solutions.

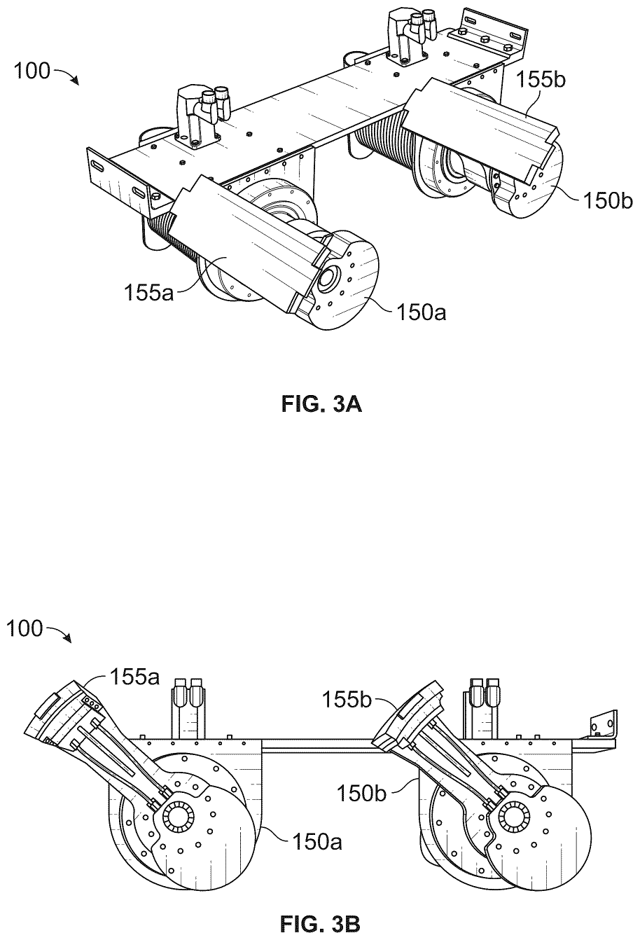

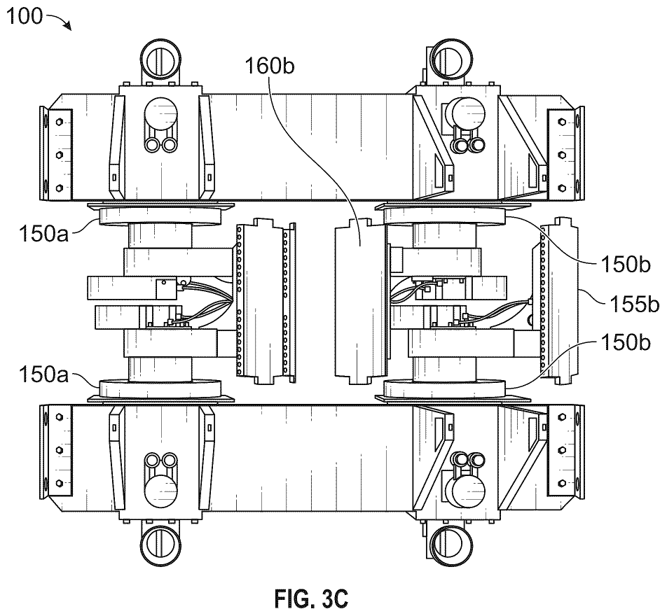

FIGS. 3A-3C illustrate an alternative rotating transfer device 150. The alternative rotating transfer device 150 is a critical component in advanced battery stacking systems, responsible for picking, aligning, and transferring electrodes (anodes and cathodes) into precise positions within the stack. The alternative rotating transfer device 150 operates by rotating one or more grippers 155 and 160 to rotating arms to pick up individual electrodes 115 and 125 and move them to the rotating picking device 170. The rotating transfer device 150 can be configured to include more than two rotating grippers per in-feed conveyor depending on the speed of the in-feed conveyor and rotating picking device 170 and if the rotating transfer device is configured to handle rejection. The time that the rotating transfer device 150 takes to rotate to the rejection position and dispose of an electrode 115 or 125 is longer than the required time to feed the next electrode 115 or 125 to the rotating picking device 170. By adding more rotating grippers, the rotating transfer device can maintain continuous in-feeding and prevent a slowdown during stacking. In an embodiment, the rotating transfer device comprises at least two rotating grippers 155 and 160 per in-feed conveyor.

The rotating transfer device 150 includes multiple vacuum zones that are configured and operate as described above. In an embodiment, the rotating transfer device 150 includes at least two vacuum zones.

The alternative rotating transfer device, 150, can also perform essential realignment tasks in real time using feedback from the quality inspection system described above. One key feature of this system is its ability to adjust electrode positioning by speeding up or slowing down its rotation to create a leading or lagging electrode placement, which allows the electrodes to be properly aligned during high-speed transfers when the misalignment is in the in-feed direction. By adjusting the rotational speed, the system compensates for any misalignments that may occur during earlier stages of production, ensuring that each electrode is precisely placed in the battery stack.

In addition to rotational adjustments, the system can make micro-adjustments in the cross-feed direction—lateral movements that further refine the electrode's positioning. This is particularly important in battery manufacturing, where even slight misalignments can lead to performance issues or safety risks. The alternative rotating transfer device 150's ability to move in rotational and lateral directions gives it the flexibility to handle different electrode shapes and sizes while maintaining high precision. The system employs advanced sensors and feedback mechanisms to detect any misalignment in real time, allowing the arm to make the necessary adjustments on the fly. This ensures the electrodes are perfectly aligned with the separators, minimizing the risk of short circuits or other defects in the final battery product.

The rejection capability of the alternative rotating transfer device 150 adds another layer of quality control. If an electrode is detected to be faulty or misaligned beyond a set tolerance, the alternative rotating transfer device 150 can reject it from the stack and redirect it to a separate bin or gripper arm (not shown) for reprocessing or disposal. This reduces the risk of defective batteries entering the final assembly, improving the overall yield and quality of the battery production process. By integrating realignment and rejection functions, the alternative rotating transfer device 150 optimizes the stacking process, ensuring consistent alignment, reducing defects, and increasing the efficiency of high-volume battery manufacturing systems.

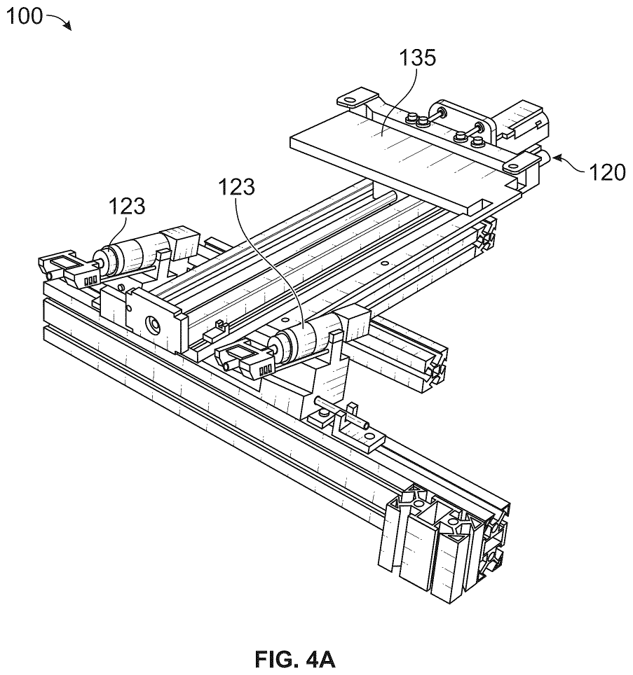

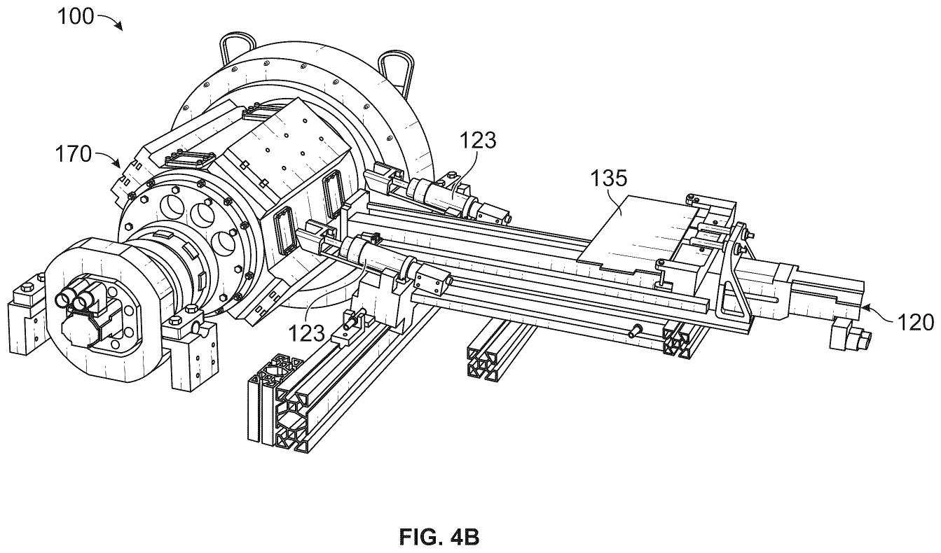

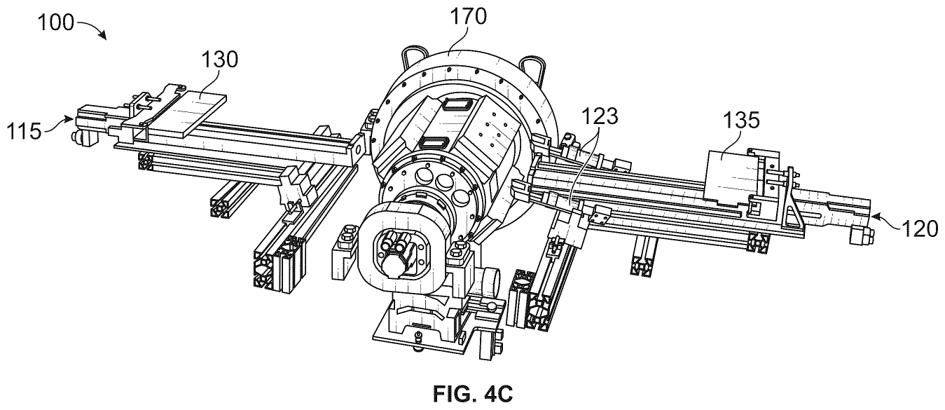

FIGS. 4A-4C illustrate alternative transportation devices 110 and 120. The in-feed conveyor systems, first transportation device 110 and second transportation device 120, for battery stacking are designed to transport singulated anode, cathode, and separator sheets from upstream processes to the rotating transfer device 150 and rotating picking device 170 with high precision and synchronization. These conveyors contain one or more lanes or belts dedicated to different materials (anode, cathode, separator) to ensure seamless feeding into the stacking process. Equipped with features like vacuum-assisted gripping mechanisms, sensors, and alignment devices, these conveyors ensure that each component is correctly positioned and aligned before entering the stacking system 100. Advanced systems often integrate tension controls, speed adjustments, and robotic arms to handle delicate and thin materials, particularly separators, which are prone to deformation. Additionally, real-time quality checks such as optical or X-ray inspection systems can be incorporated along the conveyors to detect defects in materials before they reach the stacker, ensuring consistent quality and minimizing the risk of downstream issues. The system is equipped with sensors, alignment devices, and real-time feedback mechanisms that monitor and adjust the position of each sheet as it moves along the conveyor. The singulation process ensures that only one sheet at a time is fed onto the stacking platform, preventing overlaps or misalignments that could affect the battery's performance. The continuous nature of the conveyor allows for high-speed operation, enabling consistent material flow while minimizing the need for manual intervention, ensuring high throughput and precision in battery manufacturing.

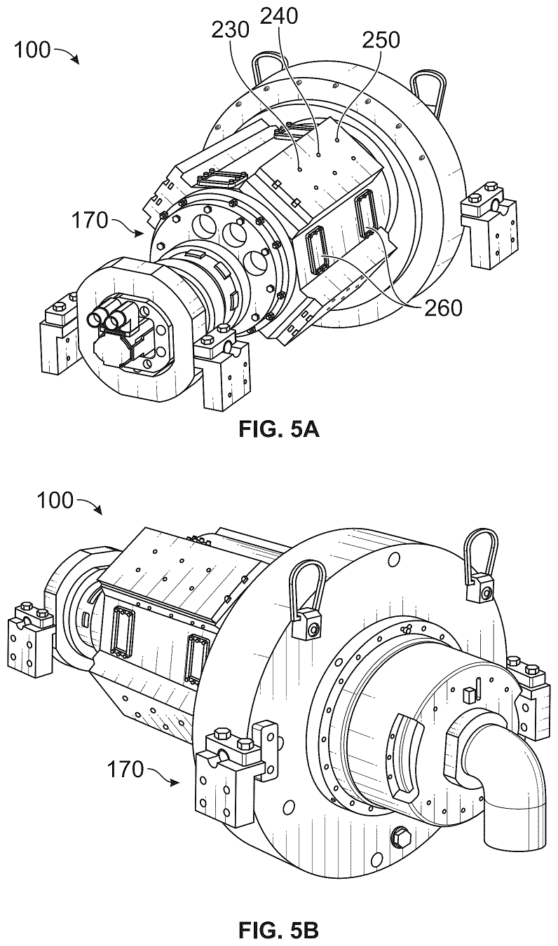

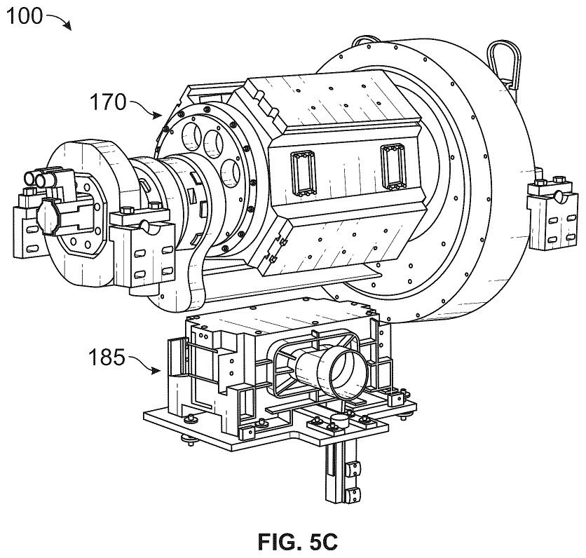

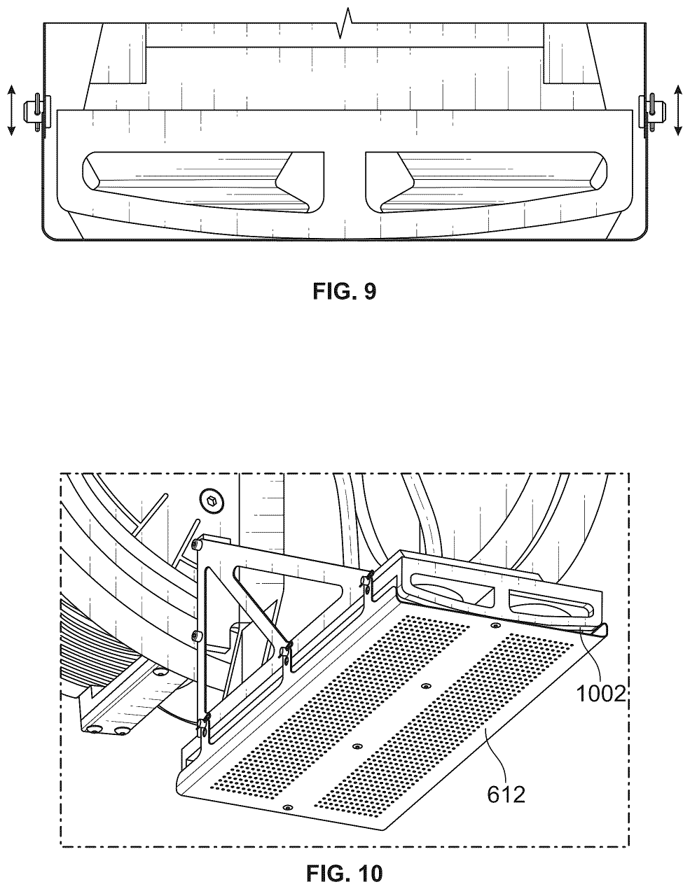

FIGS. 5A-5C illustrate the rotating picking device 170 in further detail and in reference to the alternative embodiments illustrated within FIGS. 8 and 9. The stacking system 100 is illustrated within FIG. 10 operates in the same manner as the stacking system 100 described above and illustrated in FIG. 1.

The above system and methods describe a continuous singulated battery stacking system, stacking system 100. The stacking system 100 allows for high accuracy of battery material placement because of the digital twin and alignment devices. The stacking system 100 can achieve an alignment accuracy of less than 100 microns by using the digital twin and the alignment devices to adjust the accuracy of each battery material sheet. Because the accuracy is so high, the anodes and cathodes of the stack can be configured to be substantially the same size. This allows for an increase in battery capacity and a decrease in material costs.

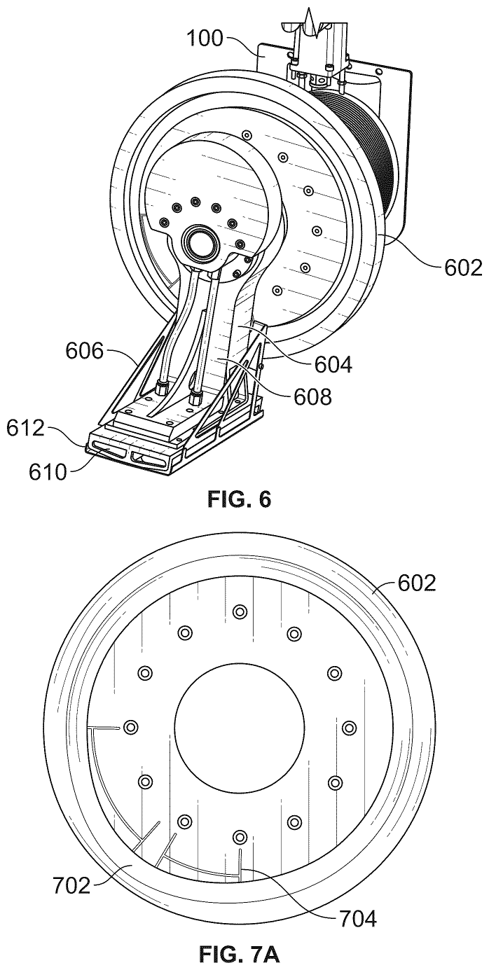

Furthermore, the stacking system 100 is capable of reaching speeds of up to 100 milliseconds per layer or 200 milliseconds per electrode, where a separator is placed in between. Achieving this speed allows for the in-feed conveyors for the stacking system 100 to directly feed singulated battery material to the stacking system 100 from the singulation lines. This allows the overall footprint of the stacking system 100 to be greatly reduced due to no longer needing intermediary accumulation regions. FIG. 6 illustrates an embodiment of the present disclosure based on the rotating transfer device 150 depicted in FIGS. 3A-5C, including a (flexible) deformable shoe 612. FIG. 6 depicts a rotating transfer device 150 composed of several interconnected components, all critical to its functionality. The existing clock arm assembly 100 is in reference to the rotating transfer device depicted in FIGS. 3A-5C. This assembly is the primary rotational mechanism for controlling the movement and timing within the rotating transfer device 150, ensuring precise coordination of the rotating transfer device 150, transportation devices 110 and 120, and rotating picking device 170.

As illustrated, the rotating transfer device 150 includes a cam plate 602. The cam plate 602 is designed to control the movement and timing of the rotating transfer device 150's components throughout its rotational motion. It is directly associated with the cam follower 604, which converts the cam plate 602's rotational motion into linear motion for other components discussed below.

The cam follower 604 is coupled to the pull strap 606. The pull strap 606 is essential for transferring force or motion from the cam plate 602 to the deformable shoe 612. The pull strap 606 is deflected up or down depending on the position of the cam follower 604 on the cam plate 602. The bellow seals 610 create a fluid seal for the deformable shoe's vacuum and air jet operation while allowing flexible movement.

The deformable shoe 612 is configured to adapt its shape match to varying surface conditions or component positioning. A curved shoe is beneficial during a rolling handoff or picking operation because it allows for smooth, continuous contact between the gripping mechanism, the electrode, and the in-feed conveyors. The curvature minimizes any abrupt changes in pressure or contact points, reducing the risk of slippage or misalignment as the electrode is transferred from one part of the system to another. This ensures a more controlled and precise movement, which is crucial for maintaining the integrity of delicate components like battery electrodes. On the other hand, a square face is advantageous when depositing electrodes onto the rotating picking device 170 because it provides a flat, stable surface that ensures even pressure distribution across the entire electrode. This stability helps achieve accurate placement without bending or misalignment, which is essential when stacking layers of electrodes in high-precision applications such as battery manufacturing. The square face also makes it easier to release the electrode cleanly, reducing the risk of sticking or shifting after deposition.

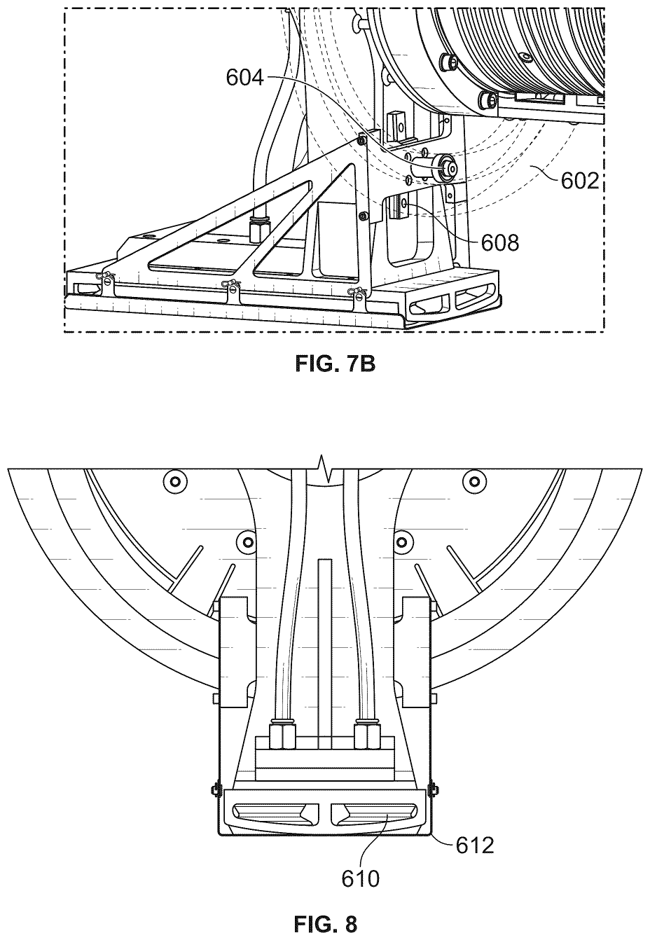

FIGS. 7A-7B illustrate the cam plate 602 and its effect on the cam follower 604 in greater detail, including the place zone 702 and pick zone 704. As shown in FIG. 7A, the cam plate 602 is a round plate that contains various zones that the cam follower 604 uses as a guide as the cam plate 602 rotates. As the cam plate 602 rotates, the cam follower 604 goes from a “round” zone to a “transition” zone and finally to a “flat” zone. When the cam follower 604 is within these zones, the deformable shoe 612 is either curved or flat. The deformable shoe 612 is curved or transitioning when the cam follower 604 is in the round and transition zones. The deformable shoe 612 is flat when the cam follower 604 is within the flat zone. The time the cam follower 604 spends within each zone is determined based on the rotating transfer device 150's arm length, rotational speed, and the timing required to pick up and deposit electrodes 115 or 125.

FIG. 7B shows the cam follower 604 is coupled to the pull strap 606 and linear bearing 608. As the cam follower 604 transitions between the zones disclosed above, the linear bearing 608 is translated up and down. The up-and-down movement of the linear bearing 608 deflects the pull strap 606 and deforms the deformable shoe 612. When the cam follower 604 moves up the linear bearing 608, the pull strap 606 is also pulled up, and the deformable shoe 612 is curved. The opposite occurs when the deformable shoe 612 is flat.

FIGS. 8 and 9 show a bellow 610 coupled to the deformable show 612. As stated above, the bellow 610 creates a seal between the vacuum source for the rotating transfer device 150 and the deformable surface of the deformable shoe 612. As illustrated, the center of the shoe is fixed to the center for the arm in FIG. 8. Similarly, as illustrated in FIG. 9, the edges of the shoe can flex as a function of the cam profile.

FIG. 10 shows the various vacuum and air jet perforations that generate either an opposing or position force during the pick and place processes. The frame of the deformable shoe 612 is curved to create a conformal radius of 1002 that acts as a stop for the thin bottom plate of the deformable shoe 612. As illustrated, while a fixed curved shoe works for a stiff electrode, a flexible electrode, such as foil lithium or a separator, needs a flat shoe surface when transitioning to the rotating picking device 170 to maintain accuracy, alignment, and quality. Furthermore, by deforming the shoe in real time, the overall forces experienced by the rotating transfer device 150 are drastically reduced. This leads to less wear and tear on the machine and allows the system to maintain accuracy, alignment, and quality.

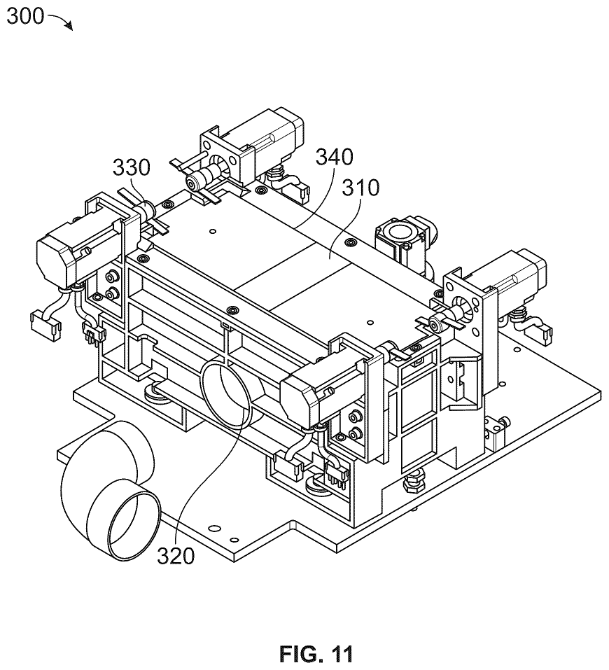

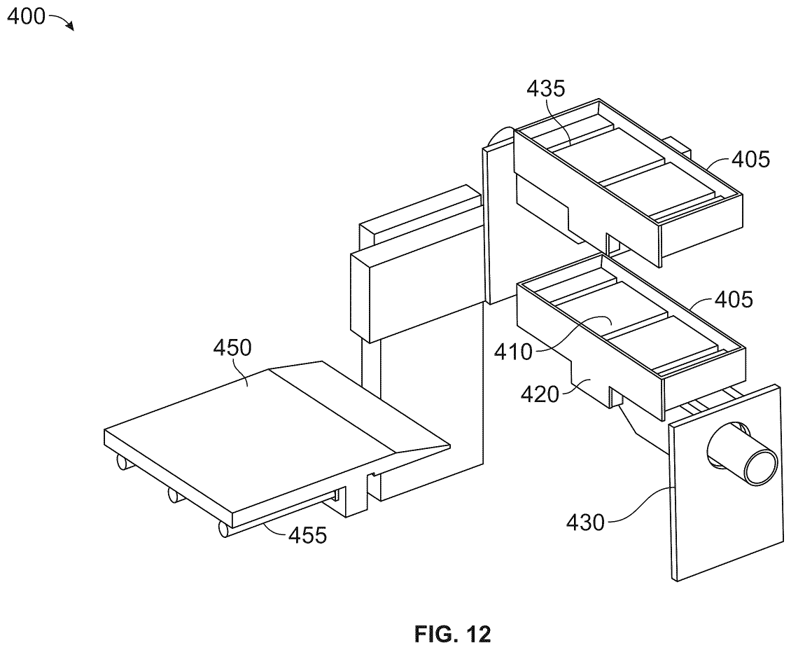

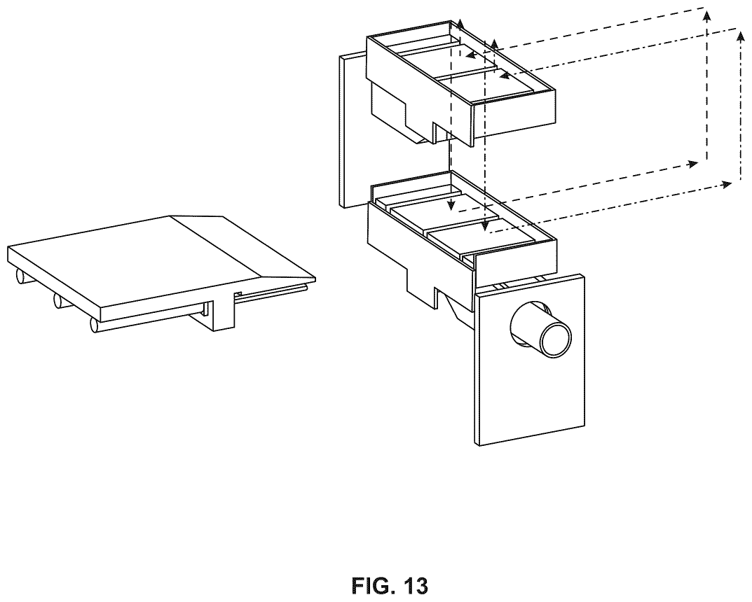

FIG. 11 shows a battery stacking station 300 according to an embodiment. The battery stacking station 300 may be the battery stacking station 185 of FIG. 1 or FIG. 2C. As illustrated, the battery stacking station 300 comprises a platform 310, onto which a battery stack will be positioned. The battery stack typically comprises alternating layers of anodes and cathodes, with separator material in between. The separator material may be in the form of a continuous sheet that is folded between the electrodes or in the form of separate sheets. The battery stacking station 300 further comprises four walls surrounding the platform and a hollow interior.

In some embodiments, the platform 310 is adapted to lower as layers of battery material are placed on it. The layers of battery material may be positioned on platform 310 by a rotating picking device 170. In some embodiments, station 300 may comprise an elevator mechanism that can lower and raise platform 310. The elevator mechanism may, in some embodiments, include a screw positioned inside station 300, below platform 310, such as a jackscrew. The battery stacking station 300 further comprises a vacuum port 320 for connection to a vacuum source. When the vacuum source is connected to the vacuum port 320, a vacuum is created inside the battery stacking station, which adheres the battery material to platform 310. Along the surrounding edge of platform 310 is a small gap 360 that generates a suction force using the vacuum source attached to vacuum port 320. The suction force generated using gap 360 creates a downward force on the surrounding edge of platform 310. As battery material is stacked on top of platform 310, the downward force generated is applied to the edges of each battery material sheet, holding it into place.

By using a vacuum to suction and adhere the battery material to platform 310, a more robust system that is less prone to misalignment and other position errors may be achieved without using mechanical solutions that may be prone to damage the battery stack. It may also help stabilize the battery stack and simplify the positioning of new battery material.

In some embodiments, station 300 may further comprise flexible clamping, meaning 330 is intended to contact the top layer of the battery stack to further fixate the battery stack on platform 310. The flexible clamping means may comprise two flaps on a rotating body, with the two flaps extending in opposite directions. The body is adapted to rotate 180 degrees when the next layer of battery material is placed on the stack, such that the flap holding down the battery stack is removed when the top layer is placed. The other flap rotates to be on top of the newly placed layer.

FIGS. 12-15 show a system 400 for battery stack removal, comprising two battery stacking stations 405 of a different embodiment than shown in FIG. 11, and shows method steps for battery stack removal using two such battery stacking stations 405. Not all features are referenced on battery station 405, but they typically comprise the same features. In some embodiments, the battery stacking stations 405 are identical.

The battery stacking stations 405 each comprise a floor 410 onto which a battery stack is placed. It further includes a front wall 420, which can be lowered. The station 405 may further comprise a hollow interior and/or be connected to a vacuum source, which creates a suction that adheres the battery stack to floor 410. In some embodiments, floor 410 is stationary and cannot be lowered or raised, as are the other three walls apart from the front wall 420.

The system further comprises a stack removal device 450, comprising prongs 455 adapted to extend from the device 450, adapted to be positioned below a formed battery stack. The battery stacking stations 405 may, in some embodiments, comprise recesses or channels 435 in the floor adapted to receive the prongs 455, positioned below the floor 410 and thus enable the prongs 455 to be positioned below the floor 410 where the bottom layer of a battery stack is positioned.

Station 405 may be positioned on arms or other mechanical transportation devices 430 adapted to transport the battery stacking station 405 along at least two axes. In some embodiments, station 405 may be moved freely in space by transportation devices 430.

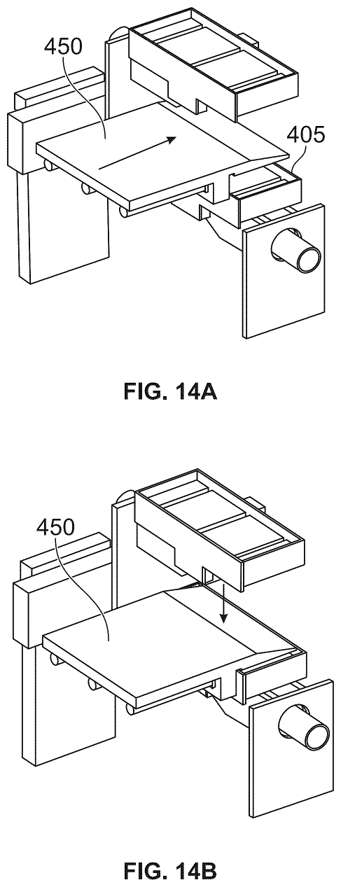

FIG. 13 shows how the battery station 405 may be moved up, down, and laterally in two opposite directions in order to position them in the system. The stations have at least four positions: a top right, bottom right, top left, and lower left position. In some embodiments, the battery station 405 may be freely and continuously positionable between these positions.

In some embodiments, the top right position is where the battery stack is positioned onto station 405, and the bottom right position is where the removal device 450 removes a completed battery stack from station 405.

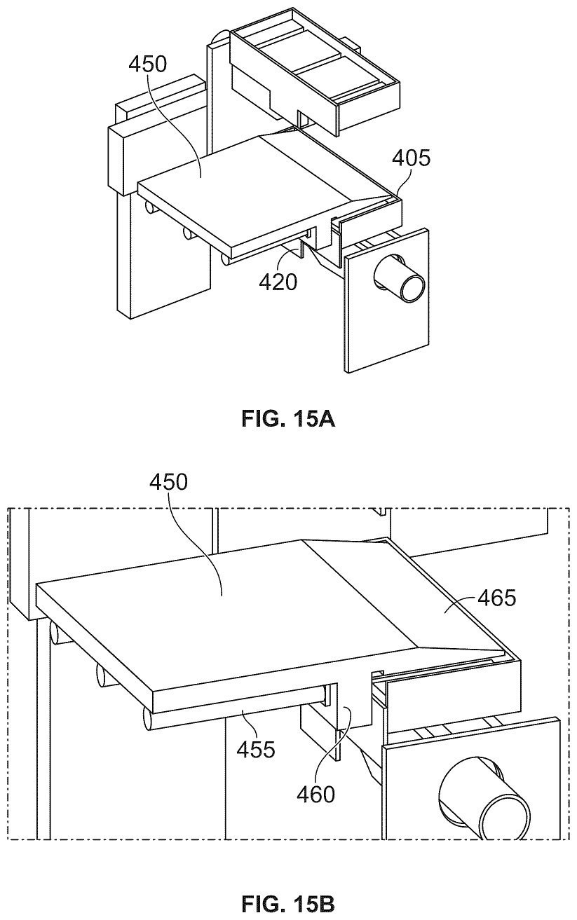

FIGS. 14A, 14B, 15A, and 15B show how the stack removal device 450 removes a battery stack from a battery stacking station 405. As illustrated, first, the removal device 450 is moved towards the bottom station 405 and is positioned above it, as shown in FIG. 14A. Then, the stack removal device 450 is moved relative to the bottom 405 stations, such that it is pressed down on the top of the battery stack (not shown) which is positioned on battery stacking station 405, as shown in FIG. 14B. In some embodiments, this entails lowering the stack removal device 450, and in some embodiments it involves raising the station 405. Then, the front wall of the battery stacking station 405 is lowered to a bottom position, as shown in FIG. 15A.

In some embodiments, the removal device 450 may comprise a front barrier 460 adapted to be positioned such that it keeps the vacuum pressure inside of the station 405 even when the wall 420 is lowered. Next, prongs 455 of the removal device 450 are extended forward and positioned in the recesses 435 of the battery stacking station 405. When the prongs 455 have been placed, the front 465 of the removal device may press down on the battery stack in order to keep it tightly positioned. Then, the battery removal device 450 may retract from the battery stacking station 405 and move the battery stack to another position for storage or further transport.

As disclosed and illustrated herein, in another embodiment, a system for battery stacking and removal is provided. It comprises two battery stacking stations 405, each with a floor, three stationary walls, and a movable wall 420. The system includes a battery removal device 450, comprising means for gripping and moving a battery stack from a battery station.

Any other undisclosed or incidental details of the construction or composition of the various elements of the disclosed embodiment of the present invention are not believed to be critical to the achievement of the advantages of the present invention, so long as the elements possess the attributes needed for them to perform as disclosed. The selection of these and other construction details are believed to be well within the ability of one of even rudimental skills in this area, in view of the present disclosure.

Illustrative embodiments of the present invention have been described in considerable detail for the purpose of disclosing a practical, operative structure whereby the invention may be practiced advantageously. The designs described herein are intended to be exemplary only. The novel characteristics of the invention may be incorporated in other structural forms without departing from the spirit and scope of the invention. The invention encompasses embodiments both comprising and consisting of the elements described with reference to the illustrative embodiments. Unless otherwise indicated, all ordinary words and terms used herein shall take their customary meaning. All technical terms shall take on their customary meaning as established by the appropriate technical discipline utilized by those normally skilled in that particular art area.

1. An apparatus for continuously stacking singulated electrodes and separators in a battery stacking system, the apparatus comprising:
a first in-feed conveyor configured to transport singulated anode sheets from an upstream singulations region;
a second in-feed conveyor configured to transport singulated cathode sheets from an upstream singulations region;
a third in-feed conveyor configured to transport singulated separator sheets from an upstream singulation region;
a transfer device having a gripping shoe, wherein the transfer device is configured to transfer an anode, a cathode, and a separator from the respective first in-feed conveyor, second in-feed conveyor, and third in-feed conveyor to a picking prism using the gripping shoe;
wherein the picking prism is further configured to pick the anode, the cathode, and the separator from the gripping shoe of the rotating transfer device using one of at least three gripping shoes coupled to the picking prism.

2. The apparatus, according to claim 1, wherein the transfer device is a rotating transfer device and the gripping shoe is a deformable vacuum-assisted gripping shoe; and wherein the rotating transfer device is adapted to alternately transfer an anode and a cathode to the rotating picking prism.

3. The apparatus, according to claim 2, wherein the rotating transfer device has at least two rotating arms.

4. The apparatus, according to claim 2, further comprising a quality inspection device adapted to inspect the cathodes, the separators, and the anodes before they are transferred to the rotating transfer device.

5. The apparatus, according to claim 2, further comprises a quality inspection device adapted to inspect the cathodes, the separators, and the anodes before they are transferred to the rotating picking prism.

6. The apparatus, according to claim 1, wherein each of the first in-feed conveyor, the second in-feed conveyor, and the third in-feed conveyor further comprises an alignment device configured to align the electrodes and separators while they are on the conveyor.

7. The apparatus, according to claim 2, wherein each of the rotating transfer devices comprises an alignment device configured to align the electrodes and separators while they are continuously in motion and transferred to the rotating picking prism.

8. A system for continuously stacking singulated electrodes and separators in a battery stacking system, comprising:
a first in-feed conveyor configured to transport singulated anode sheets from an upstream singulations region;
a second in-feed conveyor configured to transport singulated cathode sheets from an upstream singulations region;
a third in-feed conveyor configured to transport singulated separator sheets from an upstream singulation region;
a transfer device having at least one vacuum-assisted gripping shoe, wherein the transfer device is configured to transfer an anode, a cathode, and a separator from the respective first in-feed conveyor, second in-feed conveyor, and third in-feed conveyor to a rotating picking prism using the at least one vacuum-assisted gripping shoe;
wherein the rotating picking prism is further configured to pick the anode, the cathode, and the separator from the at least one vacuum-assisted gripping shoe of the transfer device using one of at least three gripping shoes coupled to the rotating picking prism.

9. The system, according to claim 8, wherein the transfer device is adapted to alternately transfer an anode and a cathode to the rotating picking prism.

10. The system, according to claim 8, wherein the transfer device has one position in which it is simultaneously gripping an anode and releasing a cathode and one position in which it is simultaneously gripping a cathode and releasing an anode.

11. The system, according to claim 8, further comprises quality inspection devices adapted to inspect the cathodes, the separators, and the anodes before they are transferred to the transfer device or to the rotating picking prism.

12. The system according to claim 8, wherein each of the first in-feed conveyor, the second in-feed conveyor, and the third in-feed conveyor further comprises an alignment device configured to align the electrodes and separators while they are on the conveyor.

13. The system, according to claim 8, wherein each of the transfer devices comprises an alignment device configured to align the electrodes and separators while they are continuously in motion and transferred to the rotating picking prism.

14. The system, according to claim 8, wherein the at least three gripping shoes coupled to the rotating picking prism further comprise a surface adapted to adhere an electrode to its surface via vacuum, wherein the surface has a plurality of vacuum zones that can be individually controlled;
a processor further configured to track an angular position of the plurality of vacuum zones;
determine that the angular position of at least one of the plurality of vacuum zones has reached a predetermined angular position; and
deactivate at least one of the plurality of vacuum zones when the predetermined angular position is reached.

15. The system according to claim 14, wherein the rotating picking prism is further adapted to push on the electrode or separator with an air jet when the vacuum is turned off.

16. A battery stacking system, comprising:
a first battery stacking station adapted to receive at least one singulated anode, at least one singulated cathode, and at least one singulated separator material;
a second battery stacking station adapted to receive at least one singulated anode, at least one singulated cathode, and at least one singulated separator material;
wherein each of the battery stacking stations is adapted to be positioned at a battery stacking position and a battery removal position; and
a removal device, adapted to remove a battery stack from either the first or second battery stacking station when it is in a battery removal position.

17. The battery stacking system, according to claim 16, wherein the first battery stacking station and second battery stacking station further comprise:
a vacuum source that is fluidly coupled to the first battery stacking station and the second battery stacking station, wherein the vacuum source is adapted to exert a suction force on the battery stack that encircles the battery stack.

18. The battery stacking system according to claim 16, wherein each battery stacking station (a) is positioned on a mechanical transportation device, and is thereby adapted to move along at least two axes that are perpendicular to each other and (b) includes a movable side wall.

19. A method for battery stacking and removal, comprising:
stacking anodes, cathodes, and separator material on a first battery stacking station at a stacking position until a first battery stack has been produced;
moving the first battery stacking station to a removal position and moving a second battery stacking station to the stacking position;
stacking anodes, cathodes, and separator material on the second battery stacking station until a second battery stack has been produced;
removing the first battery stack from the first battery stacking station.

20. The method according to claim 19, wherein the first battery stack is removed from the first battery stacking station while the second battery stack is being stacked on the second battery stacking station.

21. The method according to claim 18, further comprising moving the second battery stacking station to the removal position and the first battery stacking station back to the stacking position.

22. The method according to claim 20, wherein the first battery stacking station is moved to the battery removal position at the same time the second battery stacking station is moved to the battery stacking position, and vice versa.
